(19) United States
(12) Patent Application Publication
(10) Pub. No.: US 2026/0152665 A1
(43) Pub. Date: Jun. 4, 2026

(54) COATING COMPOSITIONS CONTAINING POLYAMIDEIMIDE POLYMERS

(71) Applicant: Solvay Specialty Polymers USA, LLC, Alpharetta, GA (US)

(72) Inventors: R. William TILFORD, Stone Mountain, GA (US); Jarrod PELLISSIER, Alpharetta, GA (US)

(21) Appl. No.: 18/707,421

(22) PCT Filed: Nov. 25, 2022
(86) PCT No.: PCT/EP2022/083359

§ 371 Date: May 3, 2024

Related U.S. Application Data
(60) Provisional application No. 63/283,656, filed on Nov. 29, 2021.

(30) Foreign Application Priority Data
Jan. 13, 2022 (EP) 22151401.1

(51) Int. Cl. C09D 177/10; C08K 5/16; C09D 7/63; C09D 179/08

(52) U.S. Cl. CPC C09D 177/10; C08K 5/16; C09D 7/63; C09D 179/08

(57) ABSTRACT

Aqueous based compositions having high solids content and stable viscosity over time containing polyamideimide polymers of high acid number and methylethanolamine.

### CROSS-REFERENCE TO RELATED APPLICATIONS

This application claims priority to the U.S. Provisional Application No. 63/283,656 filed on Nov. 29, 2021, and from European Patent Application No. 22151401.1 filed on Jan. 13, 2022, the whole content of these applications being incorporated herein by reference for all purposes.

### TECHNICAL FIELD

The present invention relates to aqueous formulations, in particular aqueous coating formulations, containing polyamideimide polymers.

### BACKGROUND ART

Polyamideimide and polyamic acid polymers (hereinafter collectively referred to as PAI) are well-known, thermally stable polymers that are used for many high performance coating applications due to their excellent adhesion, temperature resistance, and high strength. PAI is commonly utilized as a protective coating for metal substrates subjected to harsh environments, including temperature, wear, abrasion, and chemical exposure. PAI also exhibits good adhesion to silicon and other substrates.

Most PAIs are only soluble in organic solvents, typically polar aprotic solvents. Commonly used solvents belong to the class of N-methyl amide solvents, in particular N-methyl pyrrolidone (NMP). PAI compositions, once applied onto a substrate, are subjected to a thermal cure process that removes the solvent and builds molecular weight in order to achieve the optimum desired properties of the material. A critical drawback to this approach is that solvents like NMP are known to be toxic. Additionally, reduced use of volatile organic compounds as solvents is highly desirable from a sustainability point of view.

There is thus a strong desire to provide aqueous coating formulations comprising PAI polymers which are free of organic solvents.

Methods to produce aqueous PAI compositions are known, but they generally rely on hazardous complexing amines, involve the use of small amounts of polar organic solvent and/or they often exhibit poor shelf-life with constantly increasing viscosity over time.

U.S. Pat. No. 4,087,394 discloses a mixture of triethylamine and diethylethanolamine to solubilize the PAI polymer. However, a substantial quantity of solvent, furfuryl alcohol and NMP, is employed in the composition.

U.S. Pat. No. 4,259,221 discloses compositions comprising PAI, water, optionally low amounts of organic solvents and a tertiary amine or mixtures of amines. U.S. Pat. No. 4,259,221 in particular discloses the use of PAI having low amounts of free carboxylic acid groups, e.g. up to 20% of free carboxylic acid groups. A list of tertiary amines suitable for the preparation of the aqueous composition is provided, specifically: dimethylethanolamine, triethanolamine, phenylmethylethanolamine, butyldiethanolamine, phenyldiethanolamine, phenylethylethanolamine, methyldiethanolamines, and triethylamine. Exemplary compositions comprise Torlon® Al-10, which is a PAI polymer characterized by an acid number of 70-90 mg KOH/g polymer and dimethylethanolamine.

U.S. Pat. No. 6,479,581 discloses aqueous based PAI compositions which comprise a PAI polymer having a high acid number, preferably greater than 120 mg KOH/g polymer, and a tertiary aliphatic amine. The most preferred amine is triethylamine.

Most tertiary amines used in practice are relatively hazardous substances, in some cases just as much as the solvent systems they seek to displace. Triethylamine, for example, is a flammable, corrosive, and acutely toxic liquid. Alkanol-substituted amines are generally less hazardous than alkyl-substituted amines like triethylamine. For example, triethanolamine, as opposed to triethylamine, is classified as non-hazardous. However, the exchange of alkyl with alkanol substituents makes it a weaker base and a less effective neutralizing agent. Aqueous solutions using triethanolamine are more difficult to obtain and often result in large quantities of undissolved polymer particulates that must be filtered out. Other alkanol substituted amines, like butyldiethanolamine, have the right basicity but surprisingly lead to compositions whose viscosity is not stable over time.

It has now been unexpectedly found that it is possible to obtain aqueous based compositions having an optimal combination of solid content and viscosity, and whose viscosity is stable over time, by combining a PAI polymer having a high acid number with methyldiethanolamine.

Advantageously, methyldiethanolamine is classified as a non-hazardous substance. More advantageously, methyldiethanolamine can rapidly dissolve the polymer when preparing the composition.

### DISCLOSURE OF THE INVENTION

A first object of the invention is thus a composition comprising water, at least one aromatic polyamic acid/polyamideimide polymer [Polymer (PAI)] having an acid number of at least 100 mg KOH/g of polymer and methyldiethanolamine, as further defined in claim 1. The composition preferably contains 1.0 to 35.0 wt % of Polymer (PAI) with respect to the combined weight of Polymer (PAI), methyldiethanolamine and water.

In an embodiment the composition has a viscosity of 100 to 10000 cPoise.

In an embodiment Polymer (PAI) has been obtained via an acid halide process.

A second object of the invention is a method for preparing the composition.

A third object of the invention is a process for the manufacture of an article comprising the step of applying the composition on a substrate. All those objects are defined in the claims and the details about them are now provided below.

### Definitions

The use of parentheses before and after symbols or numbers identifying compounds, chemical formulae or parts of formulae has the mere purpose of better distinguishing those symbols or numbers from the rest of the text and hence said parentheses can also be omitted.

Any description, even though described in relation to a specific embodiment, is applicable to and interchangeable with other embodiments of the present invention.

Any recitation herein of numerical ranges by endpoints includes all numbers subsumed within the recited ranges as well as the endpoints of the range and equivalents.

As used herein, the singular forms “a”, “an” and “the” are intended to include the plural forms as well, unless the context clearly indicates otherwise.

### DESCRIPTION OF INVENTION

According to a first object of the invention there is provided a composition comprising an aromatic polyamic acid/polyamideimide polymer [Polymer (PAI)] which comprises recurring units, more than 50.0 mol % of said recurring units comprising at least one aromatic ring and at least one amic acid group and/or imide group [recurring units (R_{PAI})], said Polymer (PAI) characterized in that it has an acid number of at least 100 mg KOH/g of polymer, as further defined in claim 1.

The composition may comprise one or more than one Polymer (PAI).

The acid number (mg of KOH/g polymer) of Polymer (PAI) may be at least 110 and even at least 120. It may be up to the theoretical acid number for a resin that comprises only amic acid units. In certain embodiments, it may be up to 170 mg KOH/g polymer.

The acid number may be determined by titration, such as a potentiometric titration method according to ASTM D664. In particular it may be determined by the potentiometric titration method described by ASTM D664, where N-methylpyrrolidone (NMP) is the solvent, and titrants are potassium hydroxide and tributylammonium chloride.

The recurring units (R_{PAI}) are advantageously chosen from the group consisting of:

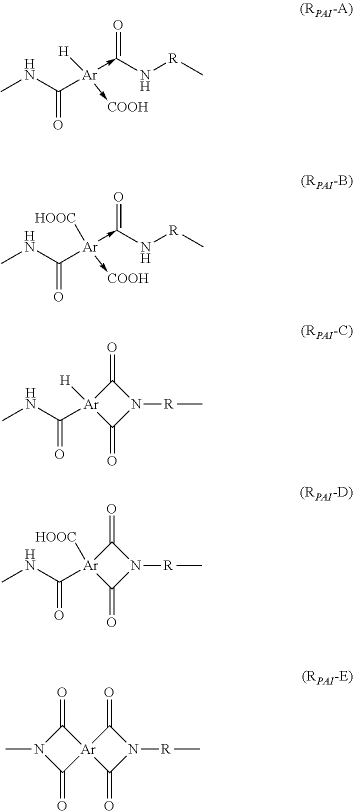

wherein:
the symbol→in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which are preferably selected from the group consisting of:

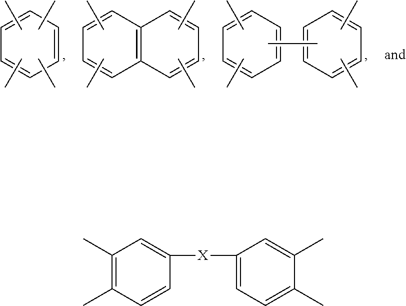

with X being selected from the group consisting of —O—, —C(O)—, —S—, —SO₂—, —CH₂—, —C(CF₃)₂—, —(CF₂)ₙ— with n=0,1,2,3,4 or 5;
—R is an aromatic divalent group, which may comprise one or more than one aromatic ring, and which are preferably selected from the group consisting of:

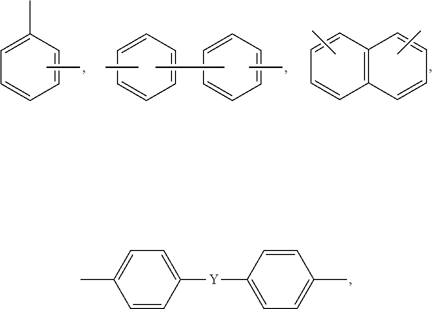

with Y being selected from the group consisting of —O—, —C(O)—, —S—, —SO₂—, —CH₂—, —C(CF₃)₂—, —(CF₂)ₙ—with n=0,1,2,3,4 or 5,

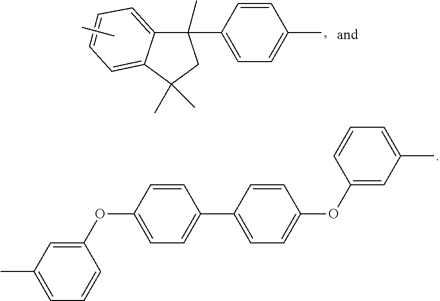

The recurring units (R_{PAI}) are preferably chosen from the group consisting of:

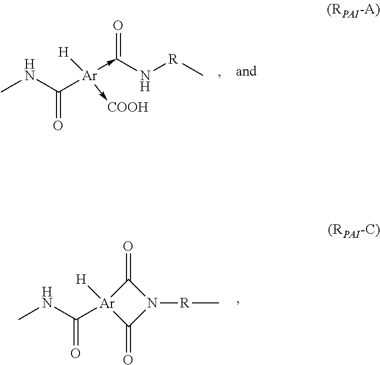

as defined above.

Recurring units (R_{PAI}) are more preferably chosen from the group consisting of units (i), (ii) and (iii), as below detailed:

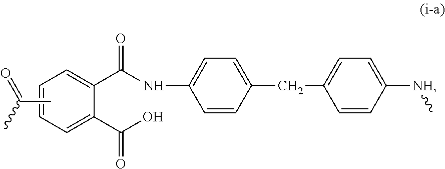

and/or the corresponding imide-group containing recurring unit:

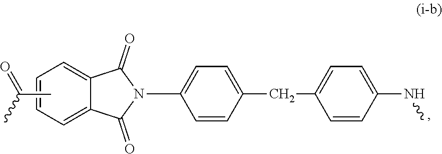

wherein the attachment of the two amide groups to the aromatic ring as shown in (i-a) will be understood to represent the 1,3 and the 1,4 polyamide-amic acid configurations;

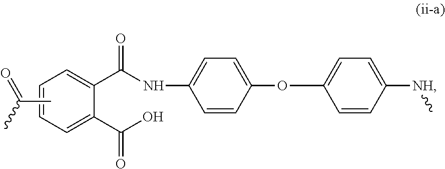

and/or the corresponding imide-group containing recurring unit:

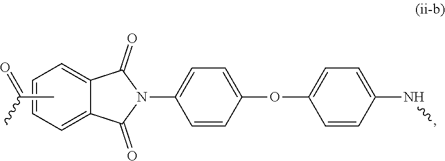

wherein the attachment of the two amide groups to the aromatic ring as shown in (ii-a) will be understood to represent the 1,3 and the 1,4 polyamide-amic acid configurations; and

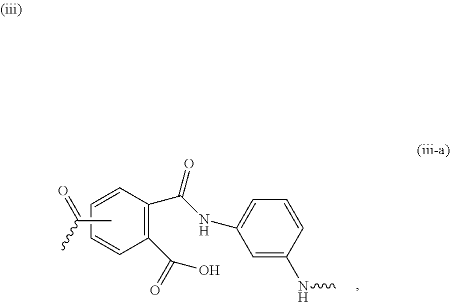

and/or the corresponding imide-group containing recurring unit:

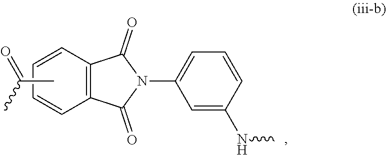

wherein the attachment of the two amide groups to the aromatic ring as shown in (iii-a) will be understood to represent the 1,3 and the 1,4 polyamide-amic acid configurations.

Recurring units (R_{PAI}) are preferably recurring units (i) or a mix of recurring units (ii) and (iii).

Preferably, Polymer (PAI) comprises more than 90.0 mol % of recurring units (R_{PAI}). Still more preferably, it contains no recurring unit other than recurring units (R_{PAI}).

Excellent results were obtained with Polymer (PAI) consisting of recurring units (i) or of a mix of recurring units (ii) and (iii).

The amount of recurring units comprising amic group can be determined by any suitable technique, such as, notably spectroscopic techniques or titration techniques which are well known to those of ordinary skills in the art.

When recurring units (R_{PAI}) are selected from those of formulae (R_{PAI}-A), (R_{PAI}-B), (R_{PAI}-C), (R_{PAI}-D), (R_{PAI}-E), as detailed above, the molar percentage of recurring units (R_{PAI}) comprising at least one amic acid group may be expressed as follows:

$$\frac{\{ [ ( {R}_{PAI} - A ) units ] + 2 \cdot [ ( {R}_{PAI} - B ) units ] + [ ( {R}_{PAI} - D ) units ] \}}{\begin{matrix}\{ [ ( {R}_{PAI} - A ) units ] + 2 \cdot [ ( {R}_{PAI} - B ) units ] + [ ( {R}_{PAI} - C ) units ] + \\ [ ( {R}_{PAI} - D ) units ] + [ ( {R}_{PAI} - E ) units ] \}\end{matrix}} \times 100$$

where [(R_{PAI}-A) units], [(R_{PAI}-B) units], [(R_{PAI}-C) units], [(R_{PAI}-D) units], and [(R_{PAI}-E) units] denote, respectively molar concentration of the different recurring units (R_{PAI}) as above described.

When recurring units (R_{PAI}) are selected from those of formulae (R_{PAI}-A), and (R_{PAI}-C), as detailed above, the molar percentage of recurring units (R_{PAI}) comprising at least one amic acid group may be expressed as follows:

$$[ ( {R}_{PAI} - A ) units ] / \{ [ ( {R}_{PAI} - A ) units ] + [ ( {R}_{PAI} - C ) units ] \} \times 100.$$

Typically at least 50.0 mol %, even at least 60.0 mol %, still at least 70.0 mol % of recurring units (R_{PAI}) comprise at least one amic acid group.

In certain embodiments 70.0 to 95.0 mol %, even 75.0 to 90.0 mol % of recurring units (R_{PAI}) comprise at least one amic acid group.

Polymer (PAI) can be manufactured by a process which includes the polycondensation reaction between at least an aromatic polycarboxylic acid halide monomer and at least an aromatic diamine.

The aromatic polycarboxylic acid halide monomer may be chosen from the group consisting of terephthaloyl chloride, isophthaloyl chloride, phthaloyl chloride, and the acid halide derivatives of trimellitic anhydride. Preferably it is selected from the trimellitic anhydride monoacid halides. Among the trimellitic anhydride monoacid halides, trimellitic anhydride monoacid chloride is preferred.

In some embodiments, a dicarboxylic anhydride monomer may be used in combination with the polycarboxylic acid halide monomer. Suitable discrboxylic anhydride monomers include pyromellitic anhydride, bis(3,4-dicarboxyphenyl) ether dianydride, and trimellitic anhydride. When a dicarboxylic anhydride monomer is used in the process, the excess of the acid halide monomer with respect to the equimolar concentration of the aromatic diamine monomer is calculated taking into consideration the combined moles of the acide halide and the dicarboxylic anhydride monomers.

The aromatic diamine monomer is selected from the group consisting of 4,4′-diaminodiphenyl ether (ODA), p-phenylenediamine, (PDA), m-phenylenediamine (MPDA), diphenyl dimethyl methane diamine (DMMDA), 1,3-bis(3-aminophenoxy)benzene (BAPB), 4,4′-bisphenol A ether diamine (BAPP), 4,4′-bis(4-aminophenoxy) diphenylsulfone (BAPS), 4,4′-bis(4-aminophenoxy) diphenyl ether (BAPE), diamino diphenyl (methyl) ketone (DABP), 4,4′-diamino-triphenylamine (DATPA), 4,4′-diaminodiphenyl methane (MDA), diaminodiphenyl sulfone (DDS), 3,4′-diaminodiphenyl ether (3,4′-ODA), 3,3 ‘-dimethyl-4,4’-diamino diphenyl methane (MDI), 4,4′-diamino-diphenoxy-1″,4″-benzene, 4,4′-diamino-diphenoxy-1″,3″-benzene, 3,3′-diamino-diphenoxy-1″,3″-benzene, 4,4′-diamino-diphenyl-4″,4-phenyl-isopropyl propane and mixtures thereof.

The aromatic diamine monomer is preferably selected from the group consisting of 4,4′-diaminodiphenyl ether (ODA), p-phenylenediamine, (PDA), and m-phenylenediamine (MPDA) and mixtures thereof. The aromatic diamine monomer may be ODA. The aromatic diamine monomer may be PDA. The aromatic diamine monomer may be MPDA.

The polycondensation reaction is advantageously carried out under substantially anhydrous conditions in a polar solvent and at a temperature below 150° C., employing a stoichiometric excess of the acid halide monomer.

A monofunctional reactant can be employed as an endcapping agent as known to the skilled in the art to control the molecular weight and to improve stability of the polymer.

Polymer (PAI) is advantageously isolated in solid form under mild conditions, preferably by being coagulated or precipitated from the polar reaction solvent by adding a miscible non-solvent, for example water, a lower alkyl alcohol or the like. Optionally, the solid resin may then be collected and thoroughly washed with water, and centrifuged or pressed to further reduce the water content of the solid without applying heat. Non-solvents other than water and lower alkyl alcohols are known and have been used in the art for precipitating Polymer (PAI) from solution including, for example, ethers, aromatic hydrocarbons, ketones and the like.

The number average molecular weight (Mn) of Polymer (PAI) is advantageously at least 1000, preferably at least 1500, more preferably at least 2000.

The number average molecular weight (Mn) of Polymer (PAI) is advantageously at most 20000, preferably at most 15000.

The molecular weight of Polymer (PAI) (Mw and Mn) may be and is usually determined using gel permeation chromatography (GPC) using a polystyrene standard.

The composition of the invention comprises advantageously at least 1.0 wt %, preferably at least 3.0 wt %, more preferably at least 5.0 wt % of Polymer (PAI) with respect to the combined weight of Polymer (PAI), methyldiethanolamine and water.

The composition of the invention comprises advantageously at most 35.0 wt %, preferably at most 30.0 wt %, more preferably at most 25.0 wt % of Polymer (PAI) with respect to the combined weight of Polymer (PAI), methyldiethanolamine and water.

For the avoidance of doubt, if the composition comprises more than one Polymer (PAI), the total amount of Polymer (PAI) is according to the proportions given herein.

Polymer compositions comprising 3.0 to 20.0 wt %, 5.0 to 20.0 wt % of Polymer (PAI) with respect to the combined weight of Polymer (PAI), methyldiethanolamine and water gave very satisfactory results.

It has been unexpectedly found that compositions comprising Polymer (PAI) in an amount of 5.0 to 20.0 wt %, even 5.0 to 15.0 wt %, possess a viscosity which is suitable for the use of said compositions in the manufacture of coatings.

Advantageously compositions essentially consisting of Polymer (PAI), methyldiethanolamine, water and wherein Polymer (PAI) is present in an amount of 5.0 to 20.0 wt % have viscosities measured at 25° C. of 100 to 10000 cPoise, typically from 300 to 8000 cPoise.

Viscosity of the compositions can be measured with a Brookfield Viscometer at 25° C.

The expression “essentially consisting” is used herein to indicate that the composition contains less than 5.0 wt %, typically less than 2.0 wt % or less than 1.0 wt %, of any other ingredient.

The composition of the invention comprises methyldiethanolamine. The minimum amount of methyldiethanolamine employed will be approximately the stoichiometric amount required to neutralize the free carboxylic acid groups in the Polymer (PAI). An excess of the amine, as much as a 3-5 fold stoichiometric excess, may be desirable. The molar ratio of amine to free carboxylic acid groups in Polymer (PAI) will generally lie in the range of from 0.8 to 5.0, preferably from 0.8 to 2.5, more preferably from 1.0 to 2.0. For the avoidance of doubt, if the composition comprises more than one Polymer (PAI), the amount of methyldiethanolamine given herein takes into account all free carboxylic acid groups present in the Polymers (PAI).

Generally, and depending upon the final solids content, the composition will comprise from 0.5 to about 30.0 wt %, even 1.0 to 20.0 wt % of methyldiethanolamine, based on total combined weight of Polymer (PAI), methyldiethanolamine and water.

Any convenient method of combining the components may be employed in preparing the aqueous compositions of the invention. The solid Polymer (PAI) may be added in increments to a stirred mixture of methyldiethanolamine and water, continuing the stirring until the solid resin has been dissolved. Alternatively, methyldiethanolamine may be added slowly to a stirred suspension of Polymer (PAI) in water, with continued stirring until the solid dissolves. As with any acid-base reaction, external cooling may be found necessary initially; subsequent warming and stirring may be desirable to complete dissolution of the solid resin in a reasonable time period. For instance, the suspension may be heated to a temperature of 50 to 90° C. and held under stirring.

It has been found that a further advantage of using methyldiethanolamine in combination with a Polymer (PAI) having a high acid number is the limited time required for achieving the dissolution of Polymer (PAI). The dissolution time is significantly lower than the time observed with PAI polymers having a lower acid number, that is lower than 100 mg KOH/g polymer.

Aqueous-based solutions according to the invention will thus comprise Polymer (PAI), water and methyldiethanolamine. Generally these aqueous-based compositions have a low level of any organic solvent, generally less than 5.0 wt %, less than 2.0 wt %, preferably less than 1.0 wt % of any organic solvent. The composition of the invention is preferably substantially free of any organic solvent. The expression “substantially free” in connection with the composition and an organic solvent is intended to mean that said organic solvent, one or more, are present in an amount of less than 0.5 wt %, preferably less than 0.2 wt % with respect to the weight of the composition. Formulations containing as little as 0.1 wt % and even lower levels of an organic solvent may also be obtainable, for example by use of extended washings. Such compositions will be highly desired for use in applications where an organic solvent cannot be tolerated. The term “solvent” is used herein to refer to an organic molecule capable of dissolving or promoting the dissolution of Polymer (PAI) and which is not methyldiethanolamine.

Depending on its final use, the composition may further comprise usual ingredients of coating compositions, such as: (i) dispersion agents; (ii) pigments like carbon black, silicates, metal oxides and sulfides; (iii) additives such as flow promoters; (iv) inorganic fillers like carbon fibers, glass fibers, metal sulfates, such as BaSO₄, CaSO₄, oxides such as Al₂O₃ and SiO₂, zeolites, mica, talc, kaolin; (v) organic fillers, preferably thermally stable polymers, like PTFE; (vi) film hardener, like silicate compounds, such as metal silicate, e.g. aluminum silicate and metal oxides, such as titanium dioxide; (vii) adhesion promoters, like colloidal silica and a phosphate compound, such as metal phosphate, e.g. Zn, Mn or Fe phosphate.

A further aspect of the invention is a process for the manufacture of an article comprising applying the inventive composition on a substrate.

Any technique may be used for the process. Typically the composition is applied by coating. Coating may be performed by any suitable coating process, such as spin coating, slit spin coating, roll coating, die coating or curtain coating. The coating step is typically followed by a step wherein the applied composition is cured by pre-baking the resulting film at a temperature comprised between 12° and 400° C., preferably between 12° and 350° C., so as to allow the solvent to be volatilized.

The thickness of the coating may vary depending on the intended purpose. The thickness is preferably in the range of from 0.1 to 100 microns, preferably from 1 to 50 microns, more preferably from 5 to 20 microns, even more preferably the thickness is of about 10 microns.

The aqueous-based compositions of this invention may be found particularly useful in formulations intended for use in coating applications, providing an adherent, high strength continuous coating layer having improved toughness on a coated surface. More generally, the aqueous-based compositions of the invention may be used to obtain adhesive or protective coatings in applications requiring resistance to friction, heat, or harsh chemical environments.

Such coatings may serve as a binder layer for automotive finishes, to improve adhesion between existing layers of automotive finishes or with other metal finishes.

PAI polymers are known for having good adhesion to metal surfaces, and aqueous-based compositions of this invention thus may be found particularly useful in providing formulations for use as enamels in container coating applications or in insulated wire applications, for instance magnet wires for electric motors.

The inventive aqueous-based compositions may be used for providing a chemically corrosion-resistant coating for metal or other substrates, for providing a binder layer for non-stick cookware; for providing a coating for tie bars for usage in cement; for providing a pre-treatment coating for polymer films such as, for example, polyester, polyamide and polyimide film, when used in a metalizing operation; as an adhesive to various plastic or metallic film materials such as liquid crystal polymers and polyimides; as an additive to improve the performance of inks.

The substantially organic solvent-free aqueous compositions of certain embodiments of the present invention may be found useful for film casting where organic solvents may not be desired or tolerated.

Formulations comprising these aqueous-based compositions may also be found useful as sizings, and particularly for fiber material such as glass fiber, carbon and graphite fiber, alumina fiber, silicon nitride fiber, boron fiber, aramid fiber, fluorocarbon fiber and the like. The term “carbon fiber” is used herein in the generic sense and includes graphite fibers as well as amorphous carbon fibers that result after a thermal carbonization or graphitization treatment.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not limitative of the present invention.

### Raw Materials

Methyldiethanolamine (MDEA), and butlydiethanolamine (BDEA)—Sigma Aldrich.

Torlon® Al-30: a PAI polymer having acid number>120 mg KOH/g polymer-commercially available from Solvay Specialty Polymers USA, LLC.

Torlon® Al-10: a PAI polymer having acid number of about 80 mg KOH/g polymer-commercially available from Solvay Specialty Polymers USA, LLC.

### METHODS

### Solution Viscosity

Viscosity of compositions was measured with a Brookfield Viscometer at 25° C. at 8.25 wt % polymer concentration.

### Acid Number Titration

Acid number is determined by potentiometric titration method described by ASTM D664, where N-methylpyrrolidone (NMP) is the solvent, and titrants are potassium hydroxide and tributylammonium chloride.

### EXAMPLE 1—AQUEOUS TORLON® AL-30 SOLUTION WITH MDEA

Water (2500 grams) and MDEA (162.4 grams) were charged into a 6 L jacketed flask fitted with overhead mechanical stirrer. The mixture was pre-heated to 80° C. With vigorous agitation, Torlon® Al-30 powder (966.4 grams) was added in five equal portions over a period of 30 minutes. Additional water (471 grams) was added to rinse all powder off the walls of the mixing vessel into the bulk liquid. The mixture was held at 80° C. for 4 hours, then pumped through a 10 micron filter bag. Initial solution viscosity was measured after 24 hours and then after 19 days. The solution was stored in a sealed glass jar at 22° C. Results are reported in Table 1.

### COMPARATIVE EXAMPLE 1—AQUEOUS TORLON® AL-30 SOLUTION WITH BDEA

Water (1500 grams) and BDEA (134.0 grams) were charged into a 6 L jacketed flask fitted with overhead mechanical stirrer. The mixture was pre-heated to 80° C. With vigorous agitation, Torlon® Al-30 powder (589.3 grams) was added in five equal portions over a period of 30 minutes. Additional water (277 grams) was added to rinse all powder off the walls of the mixing vessel into the bulk liquid. The mixture was held at 80° C. for 4 hours, then pumped through a 10 micron filter bag. Initial solution viscosity was measured after 24 hours, 4, 8 and 19 days. The solution was stored in a sealed glass jar at 22° C. Results are reported in Table 1.

TABLE 1

Viscosity (cPs)

| Days | MDEA | BDEA |
|---|---|---|
| 1 | 280 | 567 |
| 4 | — | 2241 |
| 8 | — | 30600 |
| 19 | 530 | 1100000 |

The data in Table 1 show that the viscosity of compositions comprising methylethanolamine surprisingly change very little over time when compared to compositions comprising butyldiethanolamine for which the variation is 4 orders of magnitude in a 19-day period.

It is to be noted that both in Ex. 1 and Comparative Ex. 1, the solutions were prepared with same concentration of Polymer (PAI) (about 33 wt parts per 100 parts of water), and with same molar amount of MDEA or BDEA per gram of the Polymer (PAI) (about 1.4 mmol/g of Polymer (PAI)): the examples are hence completely comparable in terms of their performances.

### COMPARATIVE EXAMPLE 2

The procedure of Example 1 was repeated using Torlon® Al-10, a PAI polymer having an acid number of 80 mg KOH/g polymer. After 8 hours the dissolution of the polymer was stopped. A significantly higher portion of undissolved solids was recovered on the filter at the end of the process than the amount recovered in Example 1.

1. A composition comprising or consisting essentially of: at least one aromatic polyamic acid/polyamideimide polymer [Polymer (PAI)], methyldiethanolamine and water, wherein Polymer (PAI) comprises recurring units, more than 50.0 mol % of said recurring units comprising at least one aromatic ring and at least one amic acid group and/or imide group [recurring units (R_{PAI})] and wherein Polymer (PAI) has an acid number of at least 100 measured as mg KOH/g of polymer.

2. A composition according to claim 1, consisting of:
at least one aromatic polyamic acid/polyamideimide polymer [Polymer (PAI)];
methyldiethanolamine;
water;
optionally in an organic molecule other than methyldiethanolamine, the proportion of which is less than 1.0 wt %, preferably less than 0.5 wt %, even more preferably less than 0.2 wt %,
wherein Polymer (PAI) comprises recurring units, more than 50.0 mol % of said recurring units comprising at least one aromatic ring and at least one amic acid group and/or imide group [recurring units (R_{PAI})] and wherein Polymer (PAI) has an acid number of at least 100 measured as mg KOH/g of polymer.

3. Composition according to claim 1 or 2 wherein the recurring units (R_{PAI}) are chosen from the group consisting of: 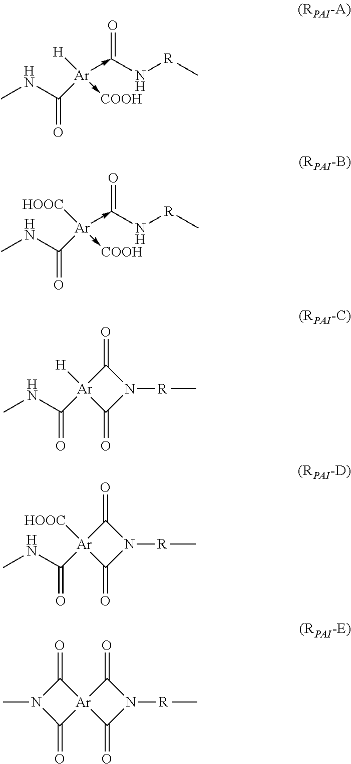
wherein:
the symbol→in each formula denotes isomerism so that, in any recurring unit within the aromatic polyamic acid structure, the groups to which the arrows point may exist as shown or in an interchanged position;
Ar is an aromatic tetravalent group, which may comprise one or more than one aromatic ring, and which is preferably selected from the group consisting of: 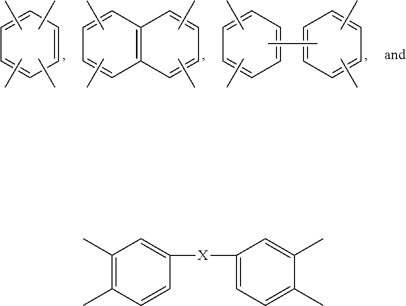
with X being selected from the group consisting of —O—, —C(O)—, —S—, —SO₂—, —CH₂—, —C(CF₃)₂—, —(CF₂)ₙ— with n=0,1,2,3,4 or 5;
R is an aromatic divalent group, which may comprise one or more than one aromatic ring, and which is preferably selected from the group consisting of: 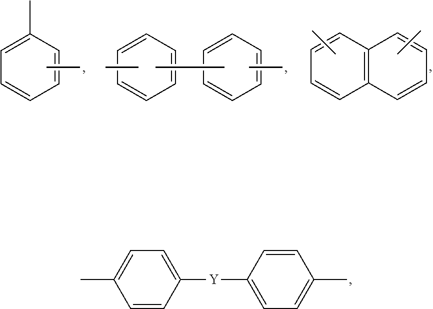
with Y being selected from the group consisting of —O—, —C(O)—, —S—, —SO₂—, —CH₂—, —C(CF₃)₂—, —(CF₂)ₙ— with n=0,1,2,3,4 or 5,

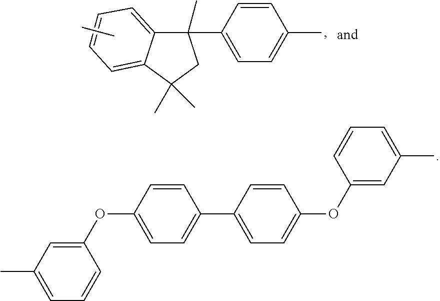

4. Composition according to any one of claims 1 to 3 wherein the recurring units (R_{PAI}) are chosen from the group consisting of units (i), (ii) and (iii): 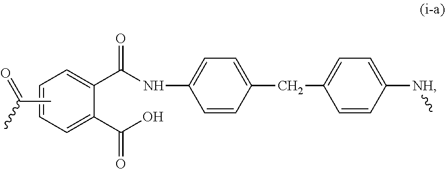
and/or the corresponding imide-group containing recurring unit: 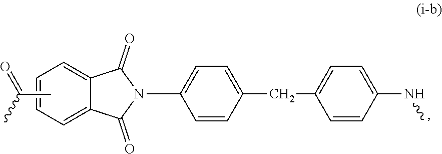
wherein the attachment of the two amide groups to the aromatic ring as shown in (i-a) will be understood to represent the 1,3 and the 1,4 polyamide-amic acid configurations; 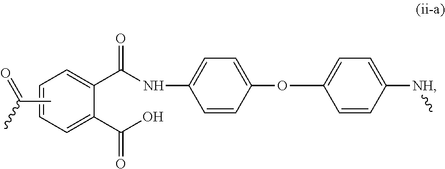
and/or the corresponding imide-group containing recurring unit: 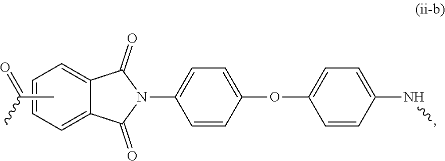
wherein the attachment of the two amide groups to the aromatic ring as shown in (ii-a) represent the 1,3 and the 1,4 polyamide-amic acid configurations; and 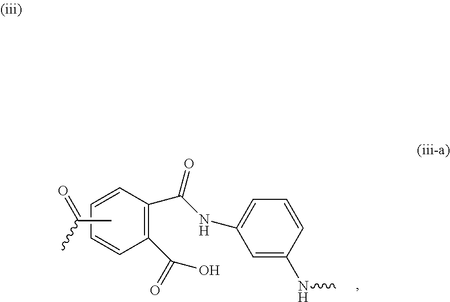
and/or the corresponding imide-group containing recurring unit: 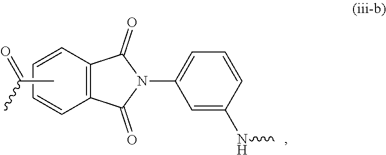
wherein the attachment of the two amide groups to the aromatic ring as shown in (iii-a) represent the 1,3 and the 1,4 polyamide-amic acid configurations.

5. Composition of any one of the preceding claims wherein Polymer (PAI) has an acid number of at least 120 measured as mg of KOH/g of polymer.

6. Composition of any one of the preceding claims comprising 1.0 to 35.0 wt %, preferably 5.0 to 20.0 wt % of Polymer (PAI) with respect to the combined weight of Polymer (PAI), methyldiethanolamine and water.

7. Composition of any one of the preceding claims comprising from 0.5 to 20.0 wt % of methyldiethanolamine, based on combined weight of Polymer (PAI), methyldiethanolamine and water.

8. Composition of any one of the preceding claims which comprises less than 1.0 wt %, preferably less than 0.5 wt %, even more preferably less than 0.2 wt %, of any organic solvent.

9. Process for the preparation of the composition of any one of the preceding claims comprising: adding Polymer (PAI) to a stirred mixture of methyldiethanolamine and water or adding methyldiethanolamine to a stirred suspension of Polymer (PAI) in water, and stirring until the solid dissolves.

10. The process of claim 9 comprising heating to a temperature of 50 to 90° C. while stirring.

11. Process for the manufacture of an article comprising coating the composition of any one of claims 1 to 8 on a substrate.

12. Process of claim 11 further comprising the step of curing the coated composition by heating at a temperature comprised between 12° and 400° C.

13. Article obtained from the process of any one of claims 11 and 12.

14. The article of claim 13 which is a magnet wire.

15. Use of the composition of any one of claims 1 to 8 for providing an enamel in the manufacture of containers or of insulated wires; for providing a corrosion-resistant coating for metal or other substrates, for providing a binder layer for non-stick cookware; for providing a coating for tie bars for usage in cement; for providing a pre-treatment coating for polymer films when used in a metalizing operation; as an adhesive to plastic or metallic film materials; as an additive in inks.
